(19) United States
(12) Patent Application Publication
(10) Pub. No.: US 2014/0106683 A1
(43) Pub. Date: Apr. 17, 2014

(54) COMMUNICATION SWITCHING DEVICE

(71) Applicant: ACROX TECHNOLOGIES CO., LTD., Taipei City (TW)

(72) Inventor: Yia-Yuan Oreyang, Taipei City (TW)

(73) Assignee: ACROX TECHNOLOGIES CO., LTD., Taipei City (TW)

(21) Appl. No.: 13/652,441

(22) Filed: Oct. 15, 2012

(51) Int. Cl. H04W 88/08

(52) U.S. Cl. 455/74.1; 455/560

(57) ABSTRACT

The communication switching device provides the plugin of a mobile communication device so that the mobile communication device is charged while plugged in. The mobile communication device has a signal transmission port. The communication switching device is also connected to the public switching telephone network and one or more telephone sets. As such, when the mobile communication device is plugged into the communication switching device for charging, the function of the mobile communication device is extended to the telephone sets through the communication switching device. A user can pick up an incoming call or make an outgoing call through the mobile communication device using any telephone set.

### TECHNICAL FIELD OF THE INVENTION

The present invention generally relates to a communication device, and especially relates to a communication switching device allowing at least a telephone set to communicate with the public switching telephone network, or to a mobile communication device while the mobile communication device is charged by the communication switching device.

### DESCRIPTION OF THE PRIOR ART

As technology is rapidly advanced, mobile communications devices (e.g., the conventional mobile phones with keypads, the recent smart phones with touch panels, etc.) have been widely applied. The popularity is mainly due to their portability, small form factor, and the ubiquitous network coverage. A user therefore can conduct two-way communication practically any place and any time. The mobile communication devices are as such indispensable accessories to people's daily life and the mainstream communication platform for both voice and data.

To achieve portability, the mobile communication devices have internal batteries as their electrical power source. To maintain the batteries' electrical power level, there are accompanied charge devices for connecting to the mains, and for charging the batteries so that they have the required voltage and current for the mobile communication devices.

However, to charge a mobile communication device when the user is indoors or in the house, the mobile communication device has to be attached to the charge device and therefore is confined to the vicinity of the charge device, thereby losing its mobility When there is an incoming call, the user has to rush to the location where the mobile communication device is charged so as to pick up the call. If the distance is too far or the user cannot hear the ring, the user would miss the call, which can be an important one.

### SUMMARY OF THE INVENTION

Therefore, a novel communication switching device is provided here which provides charging to a mobile communication device whereas the communication function of the mobile communication device is extended through the existing in-house telephone sets and wirings.

The communication switching device provides the plugin of a mobile communication device so that the mobile communication device is charged while plugged in. The mobile communication device has a signal transmission port. The communication switching device contains a base and a control circuit. The base has a connection interface matching the specification of and connecting to the signal transmission port of the mobile communication device. The base further has a first connection port, a second connection port, and a power connector. The first connection port is connected to a telephone wall socket which is connected to a public switching telephone network through a phone cable. The second connection port is connected to the telephone set through another phone cable. The power connector is connected to an external power source. The control circuit is configured inside the base, and contains a control module, and a line module connected to the control module. The control module is connected to the connection interface of the base and the power connector. The line module is connected to the first and second connection ports of the base. As such, signals of the telephone switching telephone network can be delivered to the line module via the first connection port. The line module is also connected to the connection interface of the base.

As such, when the mobile communication device is plugged into the base of the communication switching device for charging, the function of the mobile communication device is extended to the telephone set through the communication switching device. A user can pick up an incoming call or make an outgoing call through the mobile communication device using the telephone set.

The present invention also provides a communication switching device having more than one second connection port so that multiple telephone sets (corded or cordless) can be connected to the communication switching device. As such, when the mobile communication device is plugged into the base of the communication switching device for charging, a user can pick up an incoming call or make an outgoing call through the mobile communication device using any one of the telephone sets.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an application environment of a communication switching device according to an embodiment of the present invention.

FIG. 2 is a functional block diagram showing the internals of the communication switching device of FIG. 1.

FIG. 3 is a functional block diagram showing the internals of a control circuit of the communication switching device FIG. 2.

FIG. 4 is a perspective diagram showing an application environment of a communication switching device according to a second embodiment of the present invention.

FIG. 5 is a perspective diagram showing an application environment of a communication switching device according to a third embodiment of the present invention.

FIG. 6 is a functional block diagram showing the internals of the communication switching device of FIG. 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

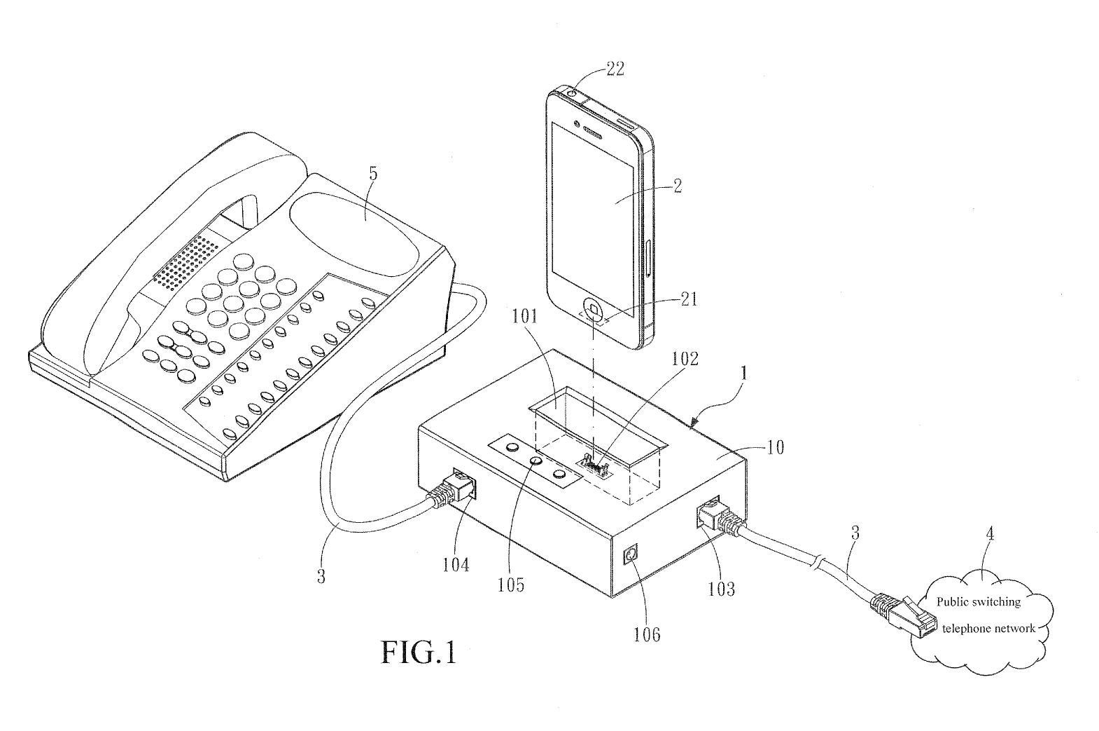

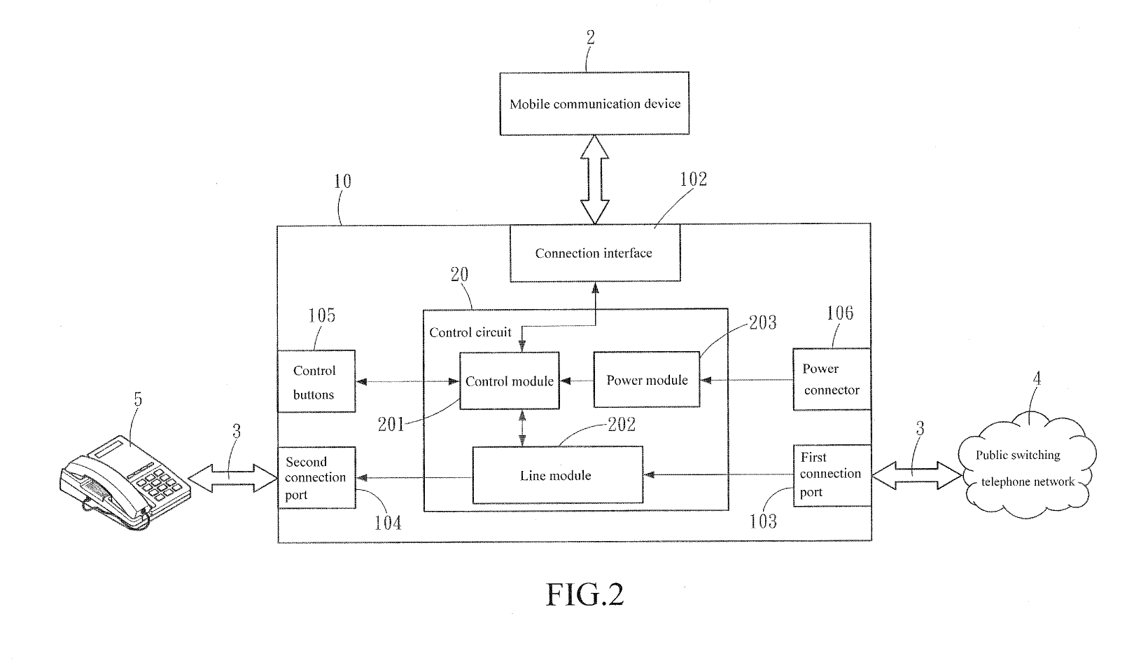

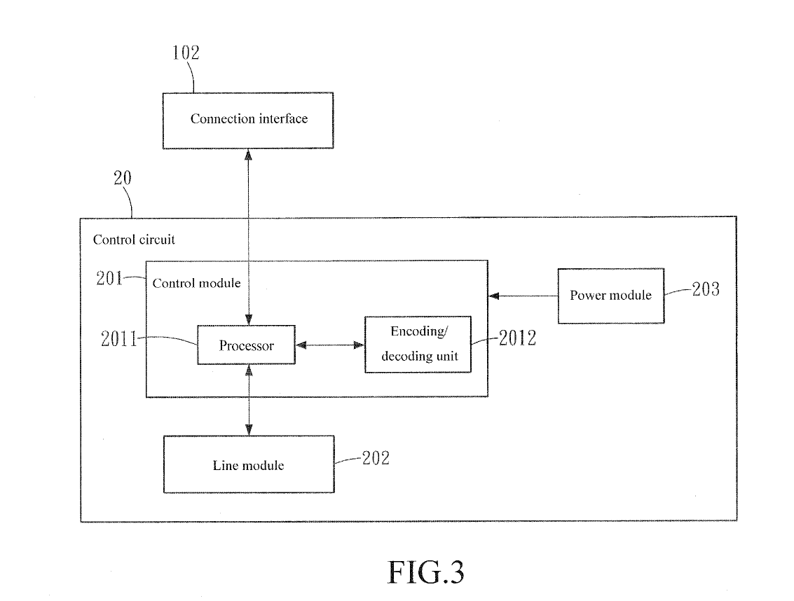

As shown in FIGS. 1 to 3, a communication switching device 1 according to an embodiment of the present invention provides the plugin of a mobile communication device 2 and the connection of a telephone set 5. While the mobile communication device 2 is plugged in, the mobile communication device 2 is charged by the communication switching device 1. The mobile communication device 2 has a signal transmission port 21 and an audio connector 22. The mobile communication device 2 can be a mobile phone with a keypad or a smart phone. The communication switching device 1 contains a base 10 and a control circuit 20.

The base 10 has at least a connection interface 102 matching the specification of and connecting to the signal transmission port 21 of the mobile communication device 2. The base 10 has an accommodation trough 101 for receiving the mobile communication device 2. The connection interface 102 is at the bottom of the accommodation trough 101. The connection interface 102 conforms to USB, Mini USB, or other specification. The base 10 further has a first connection port 103, at least a second connection port 104, control buttons 105, and a power connector 106. The first connection port 103 is connected to a telephone wall socket (which is connected to a public switching telephone network 4) through a phone cable 3. The second connection port 104 is connected to the telephone set 5 through another phone cable 3. The power connector 106 is connected to an external power source.

The control circuit 20 is configured inside the base 10, and contains a control module 201, a line module 202, and a power module 203.

The control module 201 receives at least an external signal, process the signal, and then output the processed signal. The control module 201 is connected to the connection interface 102 and the power connector 106.

The line module 202 is for switching the communication from the telephone set 5 to the mobile communication device 2 or the public switching telephone network 4. The line module 202 can be a SLIC (subscriber line interface circuit) control chip. The line module 202 is connected to the control module 201, and the first and second connection ports 103 and 104 of the base 10. As such, signals from the connection interface 102 and from the public switching telephone network 4 can be delivered to and processed by the line module 202. The line module 202 then can provide or deliver various signals to or from the telephone set 5 (such as ring voltage, dial tone, ring back tone, busy tone, dialed number, conversation voices, etc.) through the second connection port 104.

The power module 203 converts the external power source to the required voltage and current for charging the battery in the mobile communication device 2. The power module 203 is connected between the control module 201 and the power connector 106 of the base 10. The electricity from the external power source is delivered to the power module 203 through the power connector 106. The electricity is converted to that suitable for the mobile communication device 2, and then delivered to the connection interface 102 by the control module 201.

The control module 201 contains a processor 2011 and an encoding/decoding unit 2012. The processor 2011 is connected to the connection interface 102, the control buttons 105, the power connector 106, the line module 202, and the power module 203. The encoding/decoding unit 2012 is for encoding and decoding signal, and can be a codec chip. The encoding/decoding unit 2012 is connected to the processor 2011. The encoding/decoding unit 2012 processes the signals from the line module 202 for voltage conversion, and for encoding and decoding.

When a mobile communication device 2 is plugged into the base 10 of the communication switching device 1, the signal transmission port 21 of the mobile communication device 2 is connected to the connection interface 102 of the base 10. The electricity from the external power source is delivered through the power connector 106 to and converted by the power module 203 into that required by the mobile communication device 2. The control module 201 then delivers the converted electricity to the mobile communication device 2 for charging through the connection interface 102. When there is an incoming call into the mobile communication device 2, the related signals are delivered to the control module 201 through the connection interface 102, which in turn delivers the signals to the line module 202. The line module 202 then transmits the signals to the telephone set 5 through the second connection port 104. As such, the communication switching device 1 of the present invention extends the mobile communication device 2 to the telephone set 5 (which can be a corded or cordless telephone set). When the mobile communication device 2 is charged, the telephone set 5 can be used to pick up calls for the mobile communication device 2.

To make an outgoing call from the telephone set 5, the control buttons 105 can be used to select a first communication mode or a second communication mode. When the first mode is selected, the signals to/from the telephone set 5 are transmitted from/to the line module 202 through the second connection port 104. The line module 202 then processes and transmits/receives the signals to/from the public switching telephone network 4 through the first connection port 103. When the second mode is selected, the signals to/from the telephone set 5 are transmitted from/to the line module 202 through the second connection port 104. The line module 202 then processes and transmits/receives the signals to/from the mobile communication device 2 through the control module 201 and the connection interface 102.

Please note that the mobile communication device 2 can have a built-in control unit, which can be a control software, capable of interacting with the control module 201. When the mobile communication device 2 is plugged into the base 10 of the communication switching device 1, the control unit of the mobile communication device 2 is activated so that the control module 201 of the communication switching device 1 can linked to the mobile communication device 2 for two-way voice and control signal transmission.

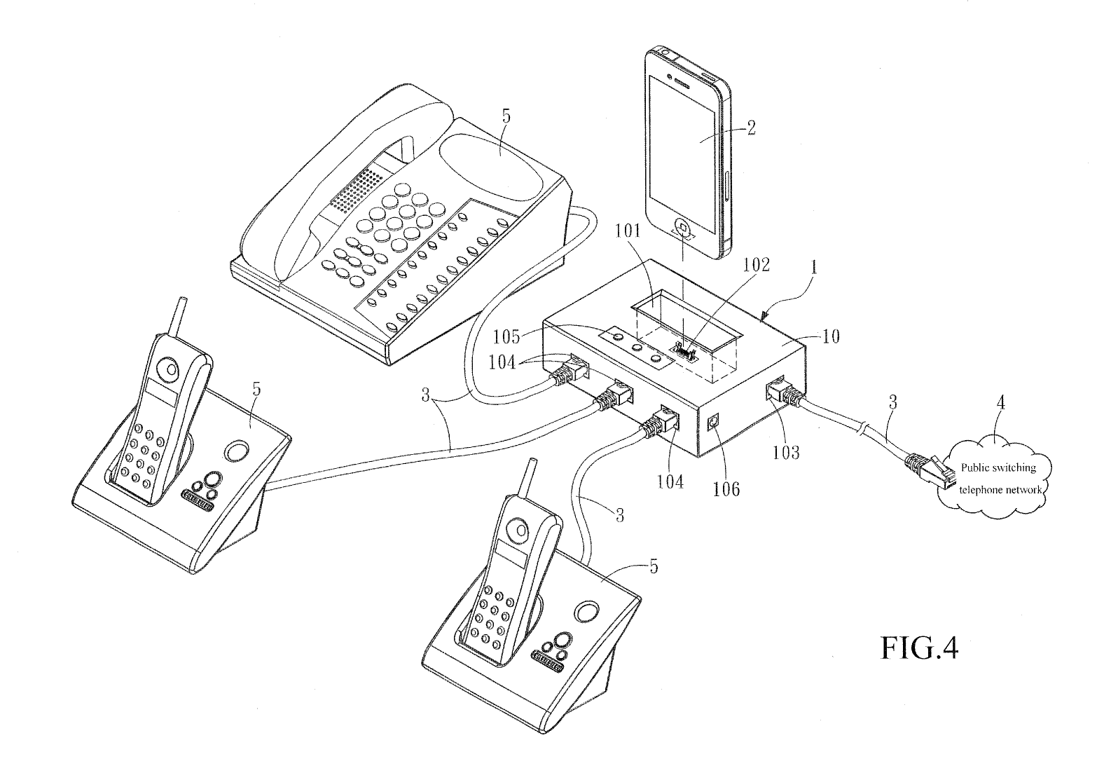

As shown in FIG. 4, the communication switching device 1 can have more than one second connection port 104, each connecting a telephone set 5 through a phone cable 3. Therefore, the communication switching device 1 can be connected to multiple telephone sets 5, which can be corded or cordless phones. Each of the telephone sets 5 can be positioned in different places of a house. When the mobile communication device 2 is plugged into the base 10 of the communication switching device 1 for charging, each of the telephone sets 5 can be used to pick up calls directed to the mobile communication device 2, or to make calls through mobile communication device 2. As such, a user is not required to move to where the mobile communication device 2 is charged so as to answer or make calls, and as such the user will not miss any important call.

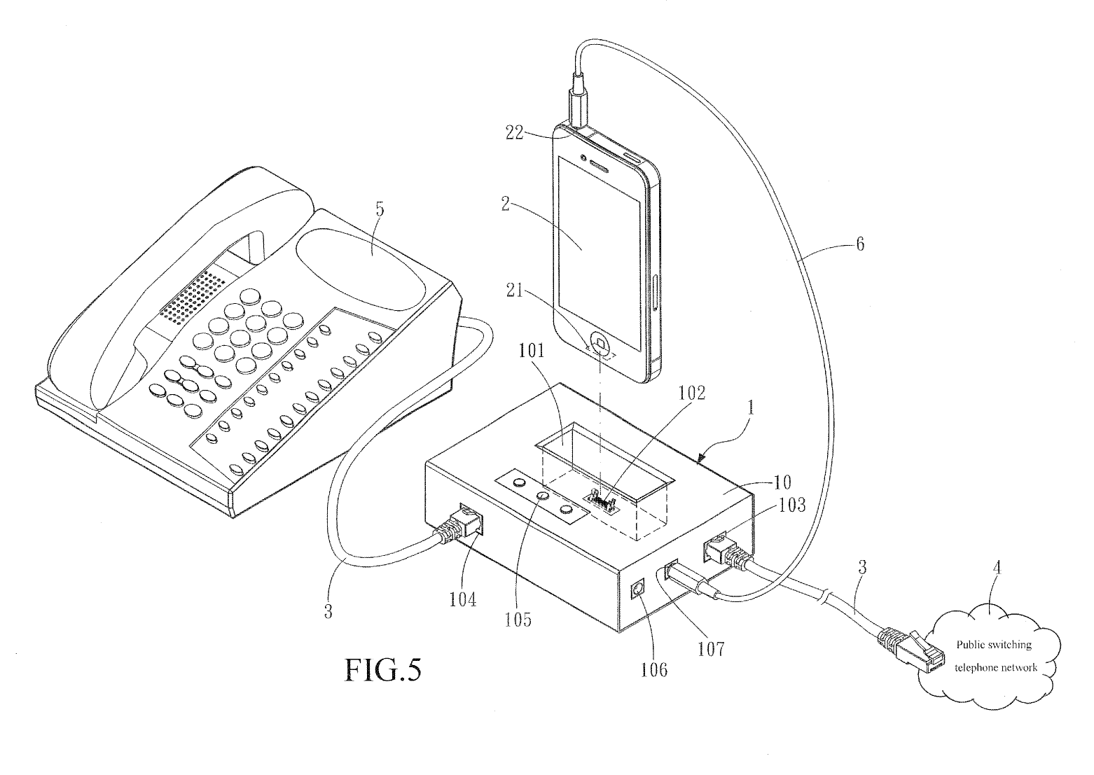

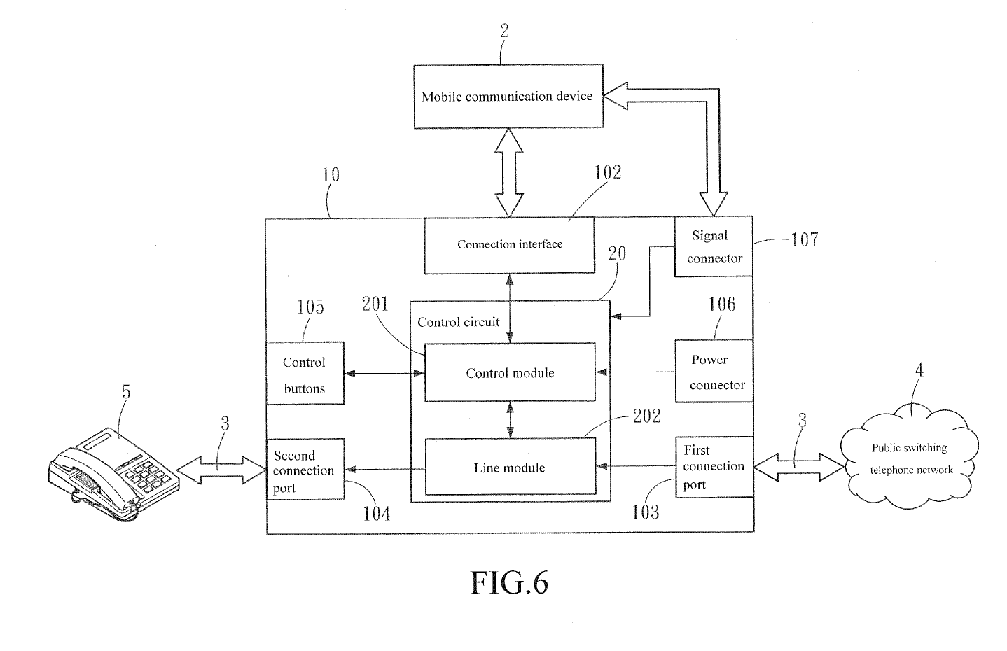

As shown in FIGS. 5 and 6, the base 10 can further have a signal connector 107 connected to the control module 201. The audio connector 22 of the mobile communication device 2 can be connected to the signal connector 107 through a transmission cable 6. As such, the mobile communication device 2 can further exchange audio signals or audio control signals with the base 10 of the communication switching device 1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A communication switching device providing the plugin of a mobile communication device having a signal transmission port, the communication switching device comprising
a base having a connection interface matching the specification of the signal transmission port of the mobile communication device, a first connection port, a second connection port, and a power connector, the first connection port connected to the public switching telephone network through a phone cable, the second connection port connected to a telephone set through another phone cable, the power connector connected to an external power source; and
a control circuit inside the base, the control circuit comprising a control module and a line module;
wherein the control module is connected to the power connector and the connection interface of the base; the control module receives at least an external signal, process the signal, and then output the processed signal; and
the line module is for switching the communication from the telephone set to the mobile communication device or the public switching telephone network; the line module is connected to the control module, and the first and second connection ports of the base.

2. The communication switching device according to claim 1, wherein the control circuit further comprises a power module for converting the electricity from an external power source to that required by the mobile communication device; and the power module is connected between the control module and the power connector.

3. The communication switching device according to claim 1, further comprising an additional connection interface for connecting an additional mobile communication device.

4. The communication switching device according to claim 1, further comprising an additional second connection port for connecting an additional telephone set.

5. The communication switching device according to claim 4, wherein the telephone set is a corded phone.

6. The communication switching device according to claim 4, wherein the telephone set is a cordless phone.

7. The communication switching device according to claim 1, wherein the control module comprises a processor and an encoding/decoding unit; the processor is connected to the connection interface and the line module; and the encoding/decoding unit is connected to the processor for signal encoding and decoding.

8. The communication switching device according to claim 1, further comprising a signal connector for connecting an audio connector of the mobile communication device through a transmission cable.

9. The communication switching device according to claim 1, wherein the mobile communication device has a built-in control unit interacting with the control module of the communication switching device.

10. The communication switching device according to claim 9, wherein the control unit is a control software.
